(19) United States
(12) Patent Application Publication
(10) Pub. No.: US 2005/0032024 A1
(43) Pub. Date: Feb. 10, 2005

(54) Sleeve attachment system and method for use in preparation of overdentures

(76) Inventors: Paulino Castellon, New Orleans, LA (US); William A. Rogers, Metairie, LA (US)

Correspondence Address: JUAN J. LIZARRAGA, 909 POYDRES STREET, SUITE 2300, NEW ORLEANS, LA, 70112-1010, US

(21) Appl. No.: 10/638,194

(22) Filed: Aug. 8, 2003

(51) Int. Cl. A61C 13/12; A61C 8/00

(52) U.S. Cl. 433/172; 433/173

(57) ABSTRACT

A sleeve attachment system and method for more precise and rapid preparation of overdentures and implant borne bar systems used to support overdentures. The system includes an elongate bar and a prefabricated sleeve with an attached retractable locking device wherein the sleeve is precisely prefitted to receive the elongate bar and the retractable locking device is precisely aligned to engage the elongate bar through an aperture in the elongate bar when the elongate bar is seated in the sleeve. The elongate bar and the sleeve with an attached retractable locking device are assembled and milled as a matched set for inclusion and use in the preparation of an implant borne overdenture prosthesis system, with the elongate bar attached as a distal end of a bar system infrastructure fitted to implants and the sleeve with attached retractable locking device cast in the underside of the overdenture such that when the overdenture is placed over the bar system infrastructure, the elongate bar seats in the sleeve and the retractable locking device engages the elongate bar creating a stable support point for the overdenture.

### BACKGROUND OF THE INVENTION

This invention relates to a sleeve attachment system and method for more precise and rapid preparation of overdentures and an implant borne bar system infrastructure used to support an overdenture.

A large percentage of senior citizens in the United States are edentulous and many wear complete dentures, which rely on the oral tissues for support, retention and stability of their prostheses. However, these individuals face decreasing retention and stability of the dentures because of bone resorption. With the advent of bone-implantable anchors, known commonly as dental implants or implants, the edentulous patient can now enjoy the benefits of a fixed/removable prosthesis or overdenture borne by implants. This type of overdenture is fixed in that there is no restriction on chewing, yet still removable to facilitate hygiene. Unfortunately, the present methods for securing an implant borne overdenture are neither simple nor cost effective, thereby effectively making them unavailable to many patients.

In addition to being complicated and cost prohibitive, the present systems and methods for preparing and installing an overdenture and an implant borne infrastucture to support that denture are time consuming for the dentist, the dental Laboratory and the patient. Because the effectiveness, comfort and function of an implant borne overdenture depends to a great deal on the fit between the bar system infrastructure supported by the implants and the overdenture itself, a great deal of time must be spent to insure that whatever attachments are used to secure the overdenture to the bar system are in alignment with the bar system and engage properly. Inaccuracies in attachment can lead to movement of the overdenture in place and cause unwanted stress, torque and lateral movement of the implants, which may lead to their failure. Implants are essentially designed to be loaded along their longitudinal axis and not in the transverse direction. Because most of the present attachment systems cannot insure such unwanted movement in the implants, a period of several months time must lapse between actual insertion of the implants and fitting of a bar system and overdenture. This time is required to allow for osseointegration, which provides some ability to withstand transverse loading, which could result from unstable attachment systems.

While overdentures can be made such that the base of the overdenture contains a continuous attachment system which engages the bar system throughout its entire length, this type of attachment is extremely costly because of the alloys used.

### SUMMARY OF THE INVENTION

It is an object of the present invention to provide a new and improved sleeve attachment system and method at less cost for more precise and rapid preparation of overdentures and an implant borne bar system for support of overdentures.

It is a further object of the present invention to provide a stable attachment system without the need for a continuous attachment system cast into an overdenture, which will reduce unwanted transverse loading of the implants with reduced time between insertion of the implants and fitting of a bar system borne by the implants to support an overdenture.

In accordance with the foregoing and other objectives of the invention, a new sleeve attachment system for use in preparation of overdentures and an implant borne bar system infrastructure used to support an overdenture is provided. The sleeve attachment system comprises; (a) at least one elongate bar with a through aperture for attachment to a distal end of the bar system infrastructure; (b) at least one sleeve, for integral casting into the underside of the overdenture, said sleeve being pre-fitted to receive the elongate bar and matched to the elongate bar as a set; (c) at least one retractable locking device fixedly attached to the sleeve and aligned to engage the through aperture in the matched elongate bar. It is a further object of this invention that this system be applicable to either the right or left distal end or both distal ends of a bar system infrastructure and the corresponding location or locations on the underside of an overdenture.

In an alternative embodiment of the sleeve attachment system, the retractable locking device comprises a swing blade pivoted in the sleeve to engage the through aperture in the elongate bar and engages the through aperture in the elongate bar from either the lingual side or the buccal side of the overdenture.

In a further alternative embodiment of the sleeve attachment system, the retractable locking device comprises a locking pin to engage the through aperture in the elongate bar and engages the through aperture in the elongate bar from either the lingual side or the buccal side of the overdenture.

It is a further object of this invention that the sleeve attachment system be applicable to either the right or left distal end or both distal ends of a bar system infrastructure and the corresponding location or locations on the underside of an overdenture.

It is also an object of the invention that the sleeve attachment system be applicable to both the upper and lower jaw.

It is a further object of the present invention that the sleeve attachment system be used in combination with at least one clip type attachment system on the anterior portion of a bar system infrastructure and the corresponding location or locations on the underside of an overdenture. In a further embodiment, the clip type attachment system comprises a ball and socket attachment system.

It is also an object of the present invention to provide a method for use in preparation of overdentures and an implant borne bar system infrastructure used to support an overdenture by (a) providing at least one elongate bar for attachment to the distal end of the bar system infrastructure as an integral part of the bar system infrastructure; (b) providing at least one sleeve, for integral casting into the underside of the overdenture; (c) providing at least one retractable locking device for attachment to the sleeve; (d) fixedly attaching retractable locking device to sleeve; (e) prefitting sleeve to receive the elongate bar; (f) creating an aperture in the elongate bar in alignment with the retractable locking device attached to sleeve when the elongate bar is received in the sleeve; (g) providing the elongate bar with aperture and the sleeve with the attached retractable locking device as a matched set for use in preparation of overdentures and an implant borne bar system infrastructure used to support an overdenture; (h) attaching the elongate bar to a distal end of the bar system infrastructure as an integral part of the bar system infrastructure; (i) aligning the sleeve with attached retractable locking device on the matching elongate bar; (j) casting the sleeve with attached retractable locking device into the underside of the overdenture such that when overdenture is placed on bar system infrastructure, the matching elongate bar is received in the sleeve and the retractable locking device is in alignment with the aperture in the elongate bar allowing immediate engagement of the locking device without additional fitting or machining.

This method further comprises the step of providing at least one clip type attachment system on the anterior portion of the bar system infrastructure and the corresponding portion of the underside of the overdenture. In a further embodiment of this method, the clip type attachment system provided comprises a ball and socket attachment system.

It is a further object of this invention that this method be applicable to either the right or left distal end or both distal ends of a bar system infrastructure and the corresponding location or locations on the underside of an overdenture.

It is also an object of this invention that this method be applicable to both the upper and lower jaw.

### BRIEF DESCRIPTION OF THE DRAWINGS

FIG. 1 is a perspective view of a sleeve with attached pivoted swing blade attachment system in juxtaposition over a matched elongate bar.

FIG. 2 is a cross section view of a sleeve with attached pivoted swing blade attachment system.

FIG. 3 is a perspective view of a sleeve with attached locking pin attachment system in juxtaposition over a matched elongate bar.

FIG. 4 is a cross section view of a sleeve with attached locking pin attachment system.

FIG. 5 is a perspective view of a lower jaw with implants and abutments.

FIG. 6 is a perspective view of a dental cast with bar system infrastructure to be borne by implants.

FIG. 7 is a perspective view of an overdenture in juxtaposition over an implant borne bar system infrastructure in a lower jaw.

FIG. 8 is a view of the underside of an overdenture.

FIG. 9 is a cross section view of an overdenture at the location of a sleeve with attached pivoted swing blade.

### DETAILED DESCRIPTION OF THE INVENTION

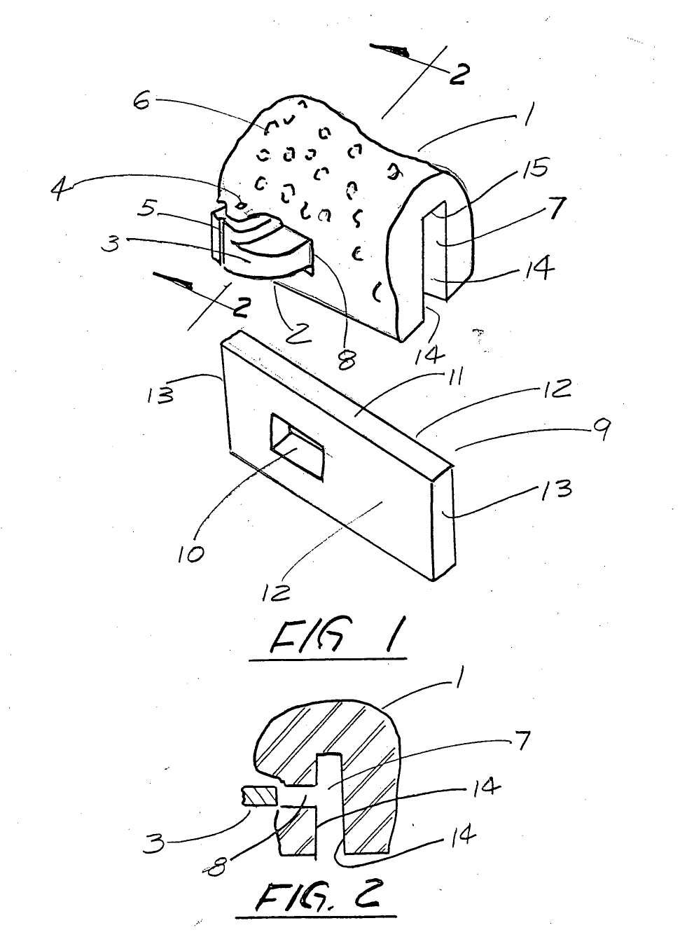

Referring now to the drawings, FIG. 1 shows a perspective view of a preferred embodiment of a sleeve 1 with an integrally cast retractable locking device 2 with a swing blade 3 on a pivot 4 with a removal groove 5. One example of such a retractable locking device is the “Swivel Loc Attachment” manufactured by Attachments International, Inc. of San Mateo, Calif. Integral with the sleeve 1 is an opening 8 for movement of the swing blade 3. It is intended that sleeve 1 will be cast into the underside of an overdenture supported by an implant borne bar system infrastructure. Since the base material of overdentures is typically cast in an acrylic compound, also shown on sleeve 1 are retention nodules 6 to enhance retention of the sleeve 1 when cast into the underside of an overdenture. In the sleeve 1 is a seating slot 7 with two side faces 14 and an upper face 15. In juxtaposition below sleeve 1 is shown an elongate bar 9 with an upper face 11, two side faces 12 and two end faces 13. The seating slot 7 in the sleeve 1 is milled or cast to receive the elongate bar 9 so that the upper face 11 of the elongate bar 9 engages the upper face 15 of the seating slot 7 in the sleeve 1 and the side faces 12 of the elongate bar 9 each engage a respective side face 14 of the seating slot 7 in the sleeve 1. Also shown in the elongate bar 9 is a through aperture 10 of such size and geometry to receive the swing blade 3 when engaged through the opening 8 in the sleeve 1 when the elongate bar 9 is received in the seating slot 7 of the sleeve 1. The elongate bar 9 is intended to be attached distally to an implant borne bar system infrastructure for supporting an overdenture and therefore one end face 13 of the elongate bar 9 will be permanently attached to the implant borne bar system infrastructure. Among the methods available for such attachment would be soldering or laser welding. Once attached to the implant borne bar system infrastructure, the elongate bar 9 will become the distal bar on either the right or left side of the infrastructure and will be cantilevered from that end of the infrastructure. The elongate bar 9 would normally be of such nominal cross sectional dimensions as compatible with the normal wax bar matrices used to cast bar system segments and which are provided commercially in 1.9×4 mm, 2.2×6 mm and 1.6×8 mm sizes. Because of such cantilevered position, normal practice would generally require that the elongate bar 9 be no longer than 10 mm. In normal practice also, the sleeve 1 and the seating slot 7 would be shorter than the elongate bar 9 to facilitate installation and the depth of the seating slot 7 would be not necessarily be the same as the height of the elongate bar 9.

It is an object of this invention that the seating slot 7 of sleeve 1 be machined to exactly receive an elongate bar 9, and the through aperture 10 in the elongate bar 9 be machined to exactly receive the swing blade 3 of the retractable locking device 2 when engaged, and that such sleeve 1 and elongate bar 9 be furnished as a matched set. As shown in FIG. 1, the sleeve 1 is cast integrally with the retractable locking device 2 and it is intended that the materials be of such precious metal alloys as are used in the bar system infrastructure.

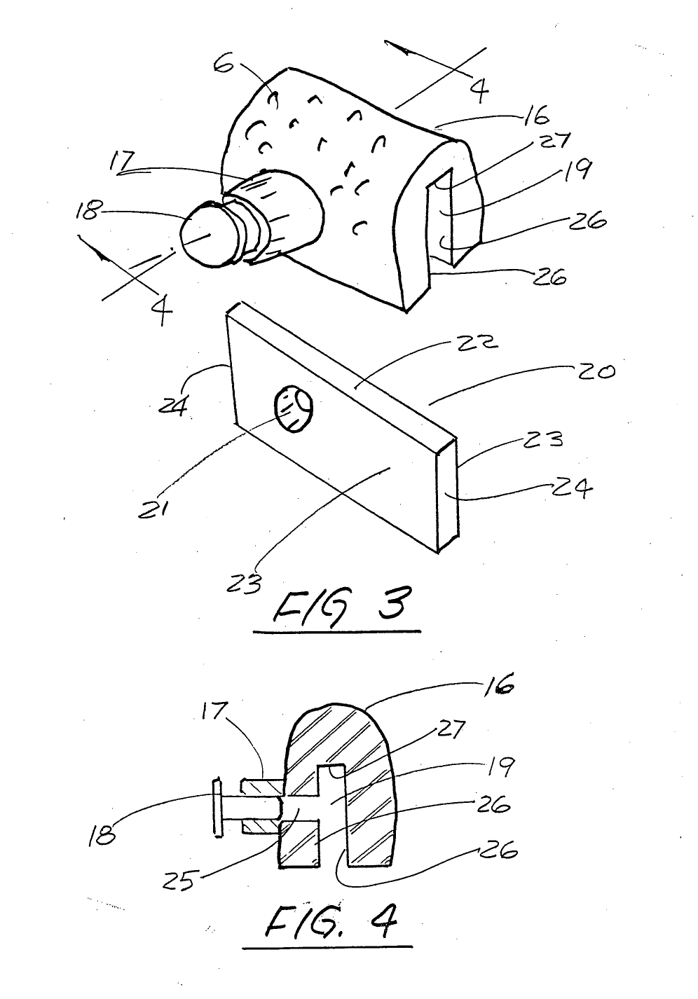

FIG. 2 is a cross section of a sleeve 1, with an integrally cast retractable locking device 2 with a swing blade 3 and an opening 8 for engagement of the locking device 2. Also shown are the two sides faces 14 and the upper face 15 of the seating slot 7 intended to respectively engage the two side faces 12 and top face 11 of the elongate bar 9 when seated in the sleeve 1.

FIG. 3 shows a perspective view of an alternate embodiment of a sleeve 16 with an attached retractable locking device 17 with a locking pin 18. One example of this type of retractable locking device is the Swiss-Loc NG. The retractable locking device 17 could be cast integrally with the sleeve 16 or attached by soldering or laser welding. Integral with the sleeve 16 is an opening 25 for movement of the locking pin 18. It is intended that sleeve 16 will be cast into the underside of an overdenture supported by an implant borne bar system infrastructure. Since the base material of overdentures is typically cast in an acrylic compound, also shown on sleeve 16 are retention nodules 6 to enhance retention of the sleeve 16 when cast into the underside of an overdenture. In the sleeve 16 is a seating slot 19 with two side faces 26 and an upper face 27. In juxtaposition below sleeve 16 is shown an elongate bar 20 with an upper face 22, two side faces 23 and two end faces 24. The seating slot 19 in the sleeve 16 is milled or cast to receive the elongate bar 20 so that the upper face 22 of the elongate bar 20 engages the upper face 27 of the seating slot 19 in the sleeve 16 and the side faces 23 of the elongate bar 20 each engage a respective side face 26 of the seating slot 19 in the sleeve 16. Also shown in the elongate bar 20 is a through aperture 21 of such size and geometry to receive the locking pin 18 when engaged through the opening 25 in the sleeve 16 when the elongate bar 20 is received in the seating slot 19 of the sleeve 16. The elongate bar 20 is intended to be attached distally to an implant borne bar system infrastructure for supporting an overdenture and therefore one end face 24 of the elongate bar 20 will be permanently attached to the implant borne bar system infrastructure. Among the methods available for such attachment would be soldering or laser welding. Once attached to the implant borne bar system infrastructure, the elongate bar 20 will become the distal bar on either the right or left side of the infrastructure and will be cantilevered from that end of the infrastructure. The elongate bar 20 would normally be of such nominal cross sectional dimensions as compatible with the normal wax bar matrices used to cast bar system segments and which are provided commercially in 1.9×4 mm, 2.2×6 mm and 1.6×8 mm sizes. Because of such cantilevered position, normal practice would generally require that the elongate bar 20 be no longer than 10 mm. In normal practice also, the sleeve 16 and the seating slot 19 would be shorter than the elongate bar 20 to facilitate installation and the depth of the seating slot 19 would be not necessarily be the same as the height of the elongate bar 20.

It is an object of this invention that the seating slot 19 of sleeve 16 be machined to exactly receive an elongate bar 20, and the through aperture 21 in the elongate bar 20 be machined to exactly receive the locking pin 18 of the retractable locking device 17 when engaged, and that such sleeve 16 and elongate bar 20 be furnished as a matched set. As shown in FIG. 3, it is intended that the materials be of such precious metal alloys as are used in the bar system infrastructure.

FIG. 4 is a cross section of a sleeve 16, with an attached retractable locking device 17 with a locking pin 18 and an opening 25 for engagement of the locking device 17. Also shown are the two sides faces 26 and the upper face 27 of the seating slot 19 intended to respectively engage the two side faces 23 and top face 22 of the elongate bar 20 when seated in the sleeve 16.

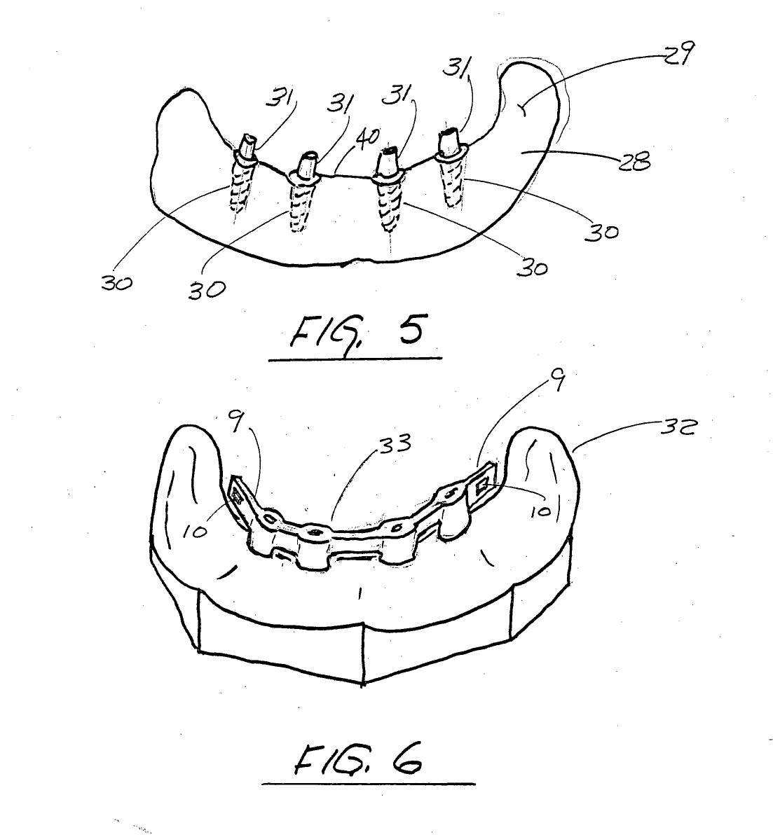

FIG. 5 is a perspective view of the lower jaw 28 of an edentulous patient with four implants 30 fitted with abutments 31 in place to receive a bar system infrastructure to support an overdenture. Also indicated is the soft tissue 29 overlying the lower jaw 28 and the alveolar ridge 40.

It should be noted that the position and placement of implants is determined by the surgeon and restorative dentist after evaluation of radiographs, the height of the alveolar ridge 40, and the amount of bone available for implant 30 placement. A master cast of the patient's mandible or maxilla is made to prepare a working model of the planned implant placement from which a surgical guide stent will be made and a bar system will be cast. A surgical guide stent is prepared in a clear material on the cast. After determining the position of the implants, implant analogs are placed in the cast at the required position and used as a guide for drilling a hole through the clear surgical stent. This surgical stent is later used in the patient's mouth to guide the surgeon in drilling and placing the implants exactly as determined on the cast of the patient's mouth.

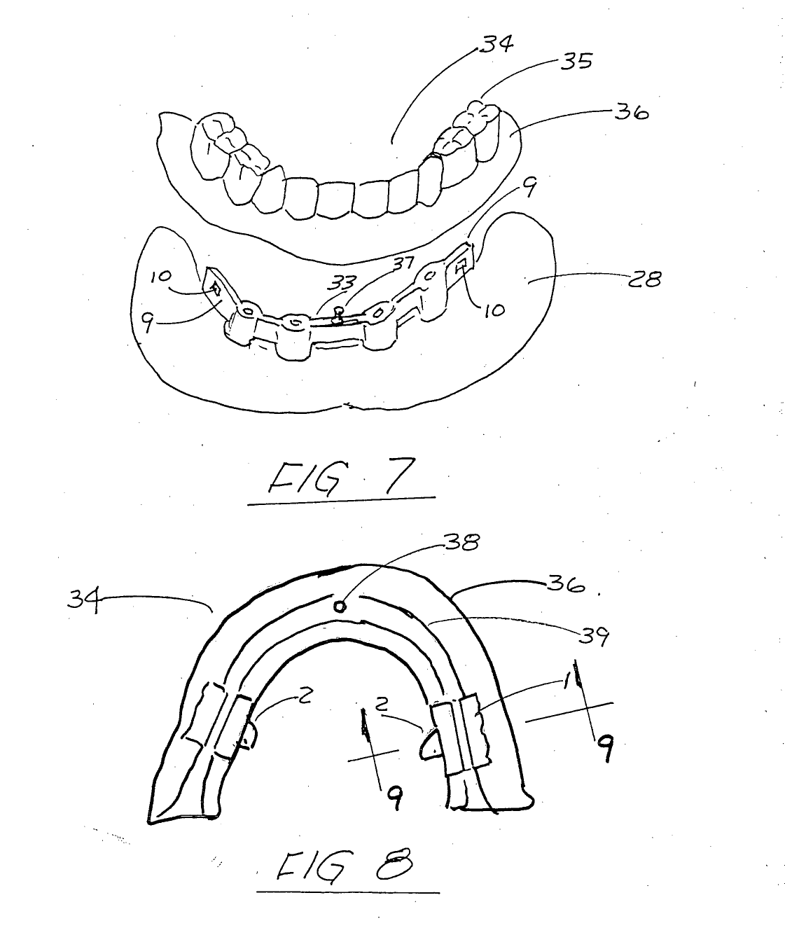

In addition to preparing the surgical stent from the patient's cast upon which implant analogs have been placed, the cast is used to prepare a bar system for support of an overdenture. FIG. 6 is a perspective view of a dental cast 32, showing a cast bar system infrastructure 33 prepared for placement on abutments 31 on implants 30 in the patient's mouth. The bar system infrastructure 33 is cast in precious metal alloy from a wax cast built on the dental cast 32. As shown in this embodiment, the distal ends of the bar system infrastructure 33 are not cast with the rest of the bar system infrastructure 33 but are rigidly attached after casting using elongate bars 9 with through aperture 10. As previously discussed each elongate bar 9 is provided with a matching sleeve 1 with attached retractable locking device 2.

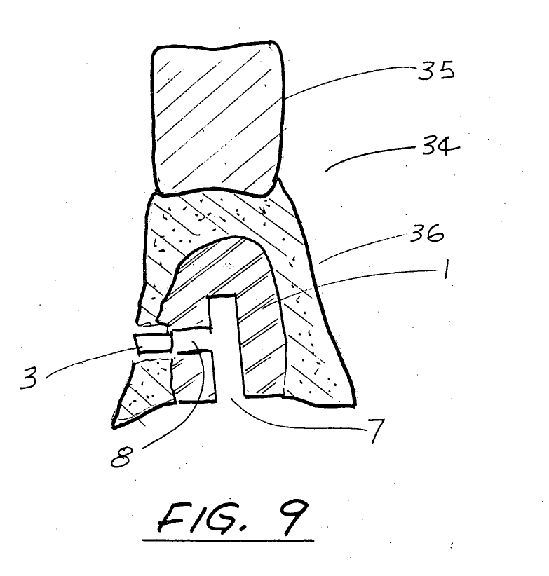

FIG. 7 is a perspective view of a completed overdenture 34 with prosthetic teeth 35 and base 36 above an implant borne bar system 33 in a patient's mouth designed to receive and support the overdenture 34. FIG. 8 is an underside view of the overdenture 34, and the base 36, showing the placement of integrally cast sleeves 1 with attached retractable locking devices 2 and a channel 39 to contain the bar system 33. Also shown is an optional anterior socket 38 to receive a ball 37 on the bar system 33 to stabilize the anterior portion of the overdenture 36. The anterior socket 38 and ball 37 are only one embodiment of a clip type attachment system, of which several are commercially available. As can be seen in FIG. 7, the sleeves 1 will engage the elongate bars 9 on the bar system 33 allowing for engagement of the retractable locking device 2 in the through aperture 10 in the elongate bar 9 permanently attached to distal end of the bar system 33. It is also seen that the ball 37 will engage the socket 38.

FIG. 9 is a cross section view of the overdenture 34 at the location of the sleeve 1 with integral retractable locking device 2 with swing blade 3, cast into the base 36 of the overdenture 34, also showing the seating slot 7 to receive the elongate bar 9 and the opening 8 for engagement of the locking device 2.

It is a further object of this invention that the machining and matching between sleeve 1 and elongate bar 9 or between sleeve 16 and elongated bar 20 be performed under what is commonly termed “precision” standards of machine tool quality. In existing practice, fitting an attachment sleeve to the distal bar of a bar system infrastructure is done to “semi-precision” standards in that the preparation of a through aperture to receive a retractable locking device is done by hand with the distal bar in place on a dental cast. By providing a matched set of sleeve with retractable locking device and elongate bar, the actual laboratory time needed to build and fit an overdenture and implant borne bar system to support the overdenture has been reduced by at least four to five hours, which time benefits the patient by reducing the number of office visits.

1. A sleeve attachment system for use in preparation of an overdenture and an implant borne bar system infrastructure used to support an overdenture comprising:
a. At least one elongate bar with a through aperture for attachment to a distal end of the bar system infrastructure;
b. at least one sleeve, for integral casting into the underside of the overdenture, said sleeve being pre-fitted to receive the elongate bar and matched to the elongate bar as a set;
c. at least one retractable locking device fixedly attached to the sleeve and aligned to engage the through aperture in the matched elongate bar.

2. A sleeve attachment system as claimed in claim 1, wherein said retractable locking device comprises a swing blade pivoted in the sleeve to engage the through aperture in the elongate bar.

3. A sleeve attachment system as claimed in claim 2, wherein said swing blade engages the through aperture in the elongate bar from the lingual side of the overdenture.

4. A sleeve attachment system as claimed in claim 1, wherein said retractable locking device comprises a locking pin to engage the through aperture in the elongate bar.

5. A sleeve attachment system as claimed in claim 4, wherein said locking pin engages the through aperture in the elongate bar from the buccal side of the overdenture.

6. A method for use in preparation of an overdenture and an implant borne bar system infrastructure used to support an overdenture comprising the steps of:
a. providing at least one elongate bar for attachment to the distal end of the bar system infrastructure as an integral part of the bar system infrastructure;
b. providing at least one sleeve, for integral casting into the underside of the overdenture;
c. providing at least one retractable locking device for attachment to the sleeve;
d. fixedly attaching the retractable locking device to the sleeve;
e. prefitting the sleeve to receive the elongate bar;
f. creating an aperture in the elongate bar in alignment with the retractable locking device attached to the sleeve when the elongate bar is received in the sleeve;
g. providing the elongate bar with aperture and sleeve with attached retractable locking device as matched set for use in preparation of overdentures and an implant borne bar system infrastructure used to support an overdenture;
h. attaching the elongate bar to a distal end of the bar system infrastructure as an integral part of the bar system infrastructure;
i. aligning the sleeve with attached retractable locking device on the matching elongate bar;
j. casting the sleeve with attached retractable locking device into the underside of the overdenture such that when the overdenture is placed on the bar system infrastructure, the matching elongate bar is received in the sleeve and the retractable locking device is in alignment with the aperture in the elongate bar allowing immediate engagement of the locking device without additional fitting or machining.

7. The method of claim 6 further comprising the step of providing the application of the method of claim 6 to both the right and left sides of an overdenture and an implant borne bar system infrastructure to support the overdenture.

8. The method of claim 6 further comprising the step of providing at least one clip type attachment system on the anterior portion of the bar system infrastructure and the corresponding portion of the underside of the overdenture.

9. The method of claim 6 further comprising the step of providing at least one clip type attachment system on the anterior portion of the bar system infrastructure and the corresponding portion of the underside of the overdenture wherein the clip type attachment system comprises a ball and socket attachment system.
